(19) United States
(12) Patent Application Publication
(10) Pub. No.: US 2026/0266687 A1
(43) Pub. Date: Sep. 10, 2026

(54) SYSTEMS AND METHODS FOR PREDICTIVE MAINTENANCE USING SPEED AND STRAIN SENSING

(71) Applicant: RealSense AI, Inc., Fort Mill, SC (US)

(72) Inventors: James M. Ingerslew, Tega Cay, SC (US); Aaron Kistler, Houston, TX (US); Alan Hartman, Louisa, VA (US)

(21) Appl. No.: 19/562,531

(22) Filed: Mar. 10, 2026

Related U.S. Application Data
(60) Provisional application No. 63/769,544, filed on Mar. 10, 2025.

(51) Int. Cl. G01M 13/00; G01M 13/028; G01M 13/045

(52) U.S. Cl. CPC G01M 13/00; G01M 13/028; G01M 13/045

(57) ABSTRACT

A system for predictive maintenance of machinery, comprising: a vibration sensor configured to measure vibration data; a strain measurement component, configured to measure strain data indicative of load or force; a remote device, configured to wirelessly transmit at least one machine parameter to the vibration sensor; a microprocessor configured to receive the at least one machine parameter from the remote device, calculate at least one vibration feature from the vibration data based on the at least one machine parameter, and correlate the at least one vibration feature with the strain data to diagnose a state of the machine, including fault severity under the measured load; and, wherein the vibration sensor is further configured to transmit the at least one calculated vibration feature and the correlated strain data to a data collection and analysis device for further processing, analysis, or trending, avoiding transmission of raw vibration data.

### RELATED APPLICATION

This application claims the benefit of priority under 35 USC § 119(e) of U.S. Provisional Patent Application No. 63/769,544 filed on Mar. 10, 2025, the contents of which are incorporated herein by reference in their entirety.

### FIELD OF THE INVENTION

The present invention, in some embodiments thereof, relates to predictive maintenance and, more particularly, but not exclusively, to using sensing to inform predictive maintenance.

### BACKGROUND OF THE INVENTION

Predictive maintenance has become a cornerstone of modern industrial operations, enabling organizations to anticipate equipment failures, minimize unplanned downtime, and optimize asset performance across sectors such as manufacturing, oil and gas, aerospace, and automotive. Central to this practice are vibration sensors, which monitor mechanical vibrations to detect anomalies like misalignment, bearing wear, or imbalance. The global vibration sensor market is experiencing robust growth, projected to reach approximately USD 5.63 billion by 2030 with a compound annual growth rate (CAGR) of 7.3% from 2024, driven largely by the adoption of Industry 4.0 technologies, automation, and predictive maintenance strategies. Within this, the wireless vibration sensor segment is expanding even faster, valued at around USD 1.43 billion in 2024 and expected to grow to USD 2.14 billion by 2034 at a CAGR of 5.2%, fueled by demands for real-time condition monitoring and IIoT integration. These wireless solutions offer advantages in scalability and installation ease over traditional wired systems, making them ideal for large-scale deployments in remote or hazardous environments.

However, the state of the art in wireless vibration sensors for predictive maintenance presents significant challenges related to data management, analysis, and reliability. Conventional wireless sensors typically rely on inexpensive accelerometers to capture vibration data, either computing rudimentary features (such as overall RMS velocity) for immediate wireless transmission or streaming large volumes of raw data, often in the form of time-domain waveforms or Fast Fourier Transform (FFT) spectra, for post-processing and or analysis at a central system. This approach creates a substantial data problem: the transmission of excessive raw or unoptimized data over wireless networks consumes significant bandwidth, increases latency, and drains battery life in power-constrained devices, limiting deployment in remote or high-density industrial settings. For instance, sensors like those in leading 2026 models (e.g., Tractian Smart Trac Ultra or Fluke 3563) often prioritize sending comprehensive datasets to enable cloud-based analysis, but this exacerbates network congestion and operational costs.

Compounding this is an analysis problem, as the lack of contextual machine parameters, such as rotational speed or load, at the time of data capture hinders effective fault diagnosis. In current systems, sensors operate in isolation, without real-time access to these variables, forcing analysts to rely on assumptions or retrospective correlations during post-processing. Speed-dependent features, like harmonic orders in FFT analysis, cannot be accurately computed on-sensor without external inputs, leading to incomplete or generic datasets that require manual intervention or additional sensors. Similarly, load conditions, which directly influence vibration severity and fault progression, are not captured at all. They can be correlated in post-processing if the load of the machine was known by a central control system but this procedure is rarely done even by wired systems. This disjointed approach delays insights and reduces the efficacy of predictive models, even as AI and machine learning are increasingly integrated for anomaly detection they are not better at determining if faults are progressing or if the machine is simply more highly loaded.

Ultimately, these limitations undermine the reliability of the analysis. Without proper context, fault indicators may be misinterpreted—e.g., a vibration peak might appear benign under low load but signal imminent failure under high stress, leading to false positives, overlooked issues, or unnecessary maintenance. In industries where downtime can cost thousands per hour, this reliability gap contributes to higher operational risks and costs, despite market investments in smart sensors and IIoT.

### SUMMARY OF THE INVENTION

There is thus a need for advanced wireless vibration sensor systems that address these data, analysis, and reliability challenges by enabling on-sensor intelligence, real-time parameter integration, and correlated measurements to deliver more efficient and accurate predictive maintenance.

According to an aspect of some embodiments of the present invention there is provided a system for predictive maintenance of machinery, comprising: a vibration sensor configured to measure vibration data of a machine; a strain measurement component integrated within the vibration sensor, configured to measure strain data indicative of load or force on the machine simultaneously with the vibration data; a remote device communicatively coupled to the vibration sensor over a network, configured to wirelessly transmit at least one machine parameter, including rotational speed, to the vibration sensor at the time of vibration measurement; a microprocessor in the vibration sensor configured to wirelessly receive the at least one machine parameter from the remote device, calculate at least one vibration feature from the vibration data based on the at least one machine parameter, and correlate the at least one vibration feature with the strain data to diagnose a state of the machine, including fault severity under the measured load; and, wherein the vibration sensor is further configured to wirelessly transmit the at least one calculated vibration feature and the correlated strain data over the network to a data collection and analysis device for further processing, analysis, or trending, thereby reducing data transmission volume, transmission time, and power consumption by avoiding transmission of raw vibration data.

In an embodiment of the invention, at least one of the vibration sensor and the network is wireless.

In an embodiment of the invention, the strain measurement component is configured to trigger the vibration measurement based on detected strain changes, or the vibration sensor is configured to trigger the strain measurement based on vibration events.

In an embodiment of the invention, the vibration sensor is configured to report the calculated vibration feature and correlated strain data over a radio network for deployment across a plurality of machines in an industrial environment.

In an embodiment of the invention, the data collection and analysis device is configured to automatically adjust alarm limits or characterize fault severity in real time using received correlated vibration feature and strain data.

In an embodiment of the invention, at least one machine parameter transmitted to the sensor further includes one or more of temperature, pressure, or operational status.

In an embodiment of the invention, vibration sensor is mounted on a gearbox, pump, fan, axle, wheel bearing, drivetrain, or rotating machinery.

According to an aspect of some embodiments of the present invention there is further provided a method for predictive maintenance of machinery using a vibration sensor, comprising: measuring vibration data of a machine with the vibration sensor; measuring strain data indicative of load or force on the machine simultaneously with the vibration data using a strain measurement component integrated within the vibration sensor; receiving, at the vibration sensor, at least one machine parameter, including rotational speed, transmitted from a remote device over a wireless network at the time of vibration measurement; calculating, via a microprocessor in the vibration sensor, at least one vibration feature from the vibration data based on the at least one machine parameter; correlating the at least one vibration feature with the strain data to diagnose a state of the machine, including fault severity under the measured load; and, transmitting the at least one calculated vibration feature and the correlated strain data over the network to a data collection and analysis device for further processing, analysis, or trending, wherein the method reduces data transmission volume, transmission time, and power consumption by transmitting the at least one calculated vibration feature instead of raw vibration data.

In an embodiment of the invention, at least one of the vibration sensor, network, receiving and transmitting are wireless.

In an embodiment of the invention, the method further comprises triggering the vibration measurement based on the strain data, or triggering the strain measurement based on the vibration data.

In an embodiment of the invention, wirelessly transmitting occurs over a radio network for deployment across a plurality of machines.

In an embodiment of the invention, the method further comprises automatically adjusting alarm limits or characterizing fault severity using the correlated vibration feature and strain data at the data collection and analysis device.

In an embodiment of the invention, the at least one machine parameter wirelessly received further includes one or more of temperature, pressure, or operational status.

In an embodiment of the invention, the vibration sensor is mounted on a gearbox, pump, fan, axle, wheel bearing, drivetrain, or rotating machinery.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1 is an illustration of a combined vibration and strain sensor with capability to receive and incorporate speed data into the computations, in accordance with an exemplary embodiment of the invention;

FIG. 2 Is an illustration of the speed transmitter incorporated with protocol conversion to act as an intermediary between machine controls and the subject network system requiring a speed input, in accordance with an exemplary embodiment of the invention;

FIG. 3 is an illustration of a speed transmitter with Hall Effect and or Infrared Sensor capability acting as a tachometer of a rotating shaft, in accordance with an exemplary embodiment of the invention;

FIG. 4 is an illustration of a speed transmitter that is combined with a communications gateway, in accordance with an exemplary embodiment of the invention;

FIG. 5 is an illustration of the configuration and analysis server, in accordance with an exemplary embodiment of the invention;

FIG. 6 is an illustration of the speed transmitter being connected to machine controls using either a machine communications protocol and sending this value directly to the sensors, in accordance with an exemplary embodiment of the invention;

FIG. 7 is an illustration of the wireless network where the speed transmitter is part of a larger network, in accordance with an exemplary embodiment of the invention;

FIG. 8 is an illustration of the shaft speed transmitter data being sent to the requisite network and then sent to the mounted sensors, in accordance with an exemplary embodiment of the invention;

FIG. 9 is a flow chart describing how configuration data is sent and stored on the sensor, in accordance with an exemplary embodiment of the invention;

FIG. 10 is a flow chart describing a combination of strain and vibration as a wake up trigger and how the sensor processes, compares, stores, and sends the data, in accordance with an exemplary embodiment of the invention;

FIG. 11 is a flow chart showing sensor behavior with strain without being sent a speed, in accordance with an exemplary embodiment of the invention; and,

FIG. 12 is a flow chart using a specific speed input in combination with the strain measurement, in accordance with an exemplary embodiment of the invention.

### DESCRIPTION OF SPECIFIC EMBODIMENTS OF THE INVENTION

The present invention, in some embodiments thereof, relates to predictive maintenance and, more particularly, but not exclusively, to using sensing to inform predictive maintenance.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Generally, the present invention provides a wireless system and method for predictive maintenance of machinery that addresses the limitations of conventional wireless vibration sensors by integrating real-time machine parameter reception (such as rotational speed), on-sensor feature calculation, and simultaneous strain measurement for load-aware diagnostics. The system comprises a compact wireless vibration sensor unit incorporating an accelerometer for vibration data capture, a strain gauge for measuring load or force, a microprocessor for local processing, and a wireless transceiver for communication over a radio network. A remote device transmits machine parameters to the sensor at the time of measurement, enabling the microprocessor to compute speed-dependent vibration features (e.g., harmonics, bearing defect frequencies, gear mesh defect frequencies, or others via FFT) and correlate them with strain data to assess fault severity under actual operating conditions. This correlation can either be done on the sensor itself or at a remote location. The processed features and correlations, rather than raw data, are wirelessly transmitted to a central analysis device, reducing data volume, transmission time, and power consumption while enhancing diagnostic accuracy and reliability.

This approach transforms “dumb” wireless sensors into intelligent edge devices, allowing for efficient, context-rich predictive maintenance in industrial environments. Embodiments may include triggering mechanisms between vibration and strain measurements, support for additional parameters (e.g., temperature), and scalability for multi-machine deployments. The invention enables one skilled in the art to implement the system using standard components like MEMS accelerometers, strain gauges, low-power MCUs (e.g., ARM Cortex-M series), and protocols such as Bluetooth Low Energy or LoRa for wireless communication.

### Sending Speed to a Wireless Sensor

The following section describes the components, operation, and exemplary embodiments of systems and methods for sending speed data to a wireless sensor, referencing the drawings where applicable. It describes the components, operation, and exemplary embodiments, referencing the drawings where applicable. Terms like “coupled” mean directly or indirectly connected, and “wireless network” encompasses protocols such as Bluetooth, Zigbee, Wi-Fi, or cellular for low-power, long-range communication.

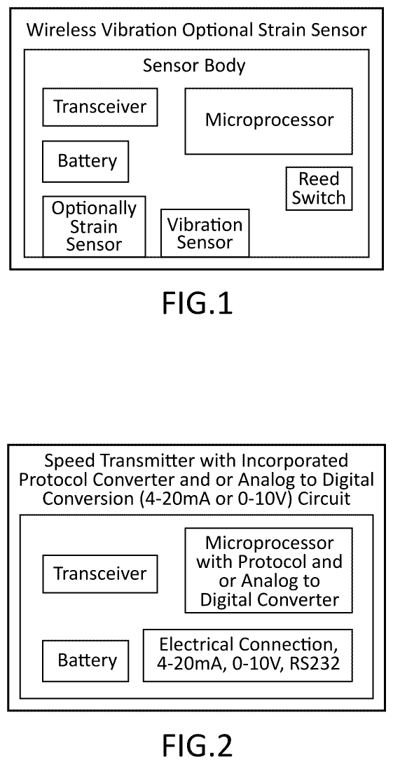

Referring now to the drawings, FIG. 1 illustrates a combined vibration and strain sensor with capability to receive and incorporate speed data into the computations, in accordance with an exemplary embodiment of the invention.

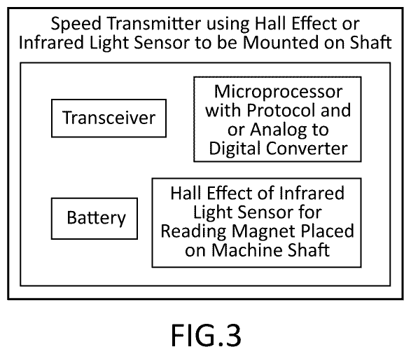

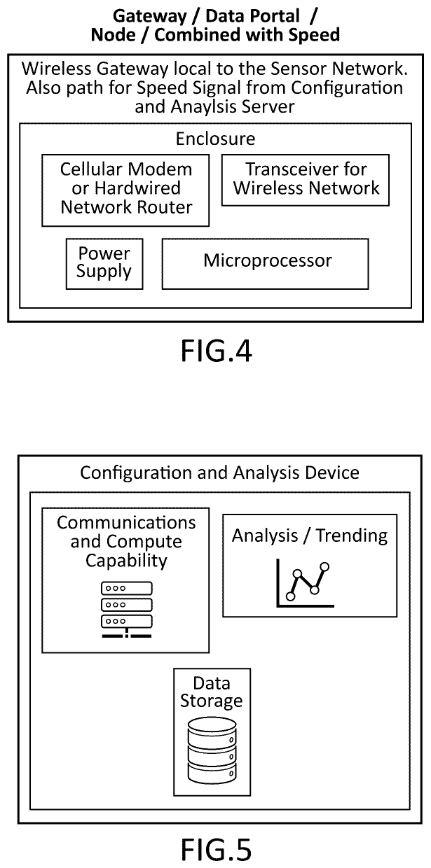

In an embodiment of the invention, the system comprises the following elements: (1) a wireless vibration sensor (shown in FIG. 1); (2) a remote device for parameter transmission (speed transmitter, shown in FIGS. 2 and 3); (3) a gateway for data transmission and relay (shown in FIG. 4); and, (4) a configuration and analysis device (shown in FIG. 5).

### (1) Wireless Vibration Sensor Unit

FIG. 1 illustrates an exemplary vibration sensor unit mounted to any machine (e.g., motor, pump, or turbine). It includes: an accelerometer capable of sampling from sub-Hz to at least 4 kHz. The sensor also optionally has a low power microprocessor meant for a system powered by a battery operating at 2.0 to 3.3 V, in some embodiments. In some embodiments, the microprocessor can use either external analog to digital converter or use one integrated to the microprocessor. In some embodiments of the invention, the microprocessor has the capability of performing at least 100,000 samples per second and simultaneously sample the strain channel.

In some embodiments, it includes a wireless transceiver supporting Bluetooth Low Energy, Lora, Wi-Sun or similar wireless protocol for receiving parameters and transmitting processed data.

In some embodiments, it uses a standard lithium-ion battery, a rechargeable battery, or use energy harvesting (vibration-powered piezoelectric) or a combination of the two. Flash or other non-volatile memory for storing configuration data and executable instructions.

The unit is optionally of compact design (e.g., 50×50×20 mm enclosure) that allows for easy attachment via at least one magnet, adhesive, and/or mechanical fastener.

### (2) Speed Transmitter And/or (3) Gateway Device

Each radio transceiver may comprise a communication interface to communicate with one or more sensors. Optionally, the communication is performed wirelessly. In some embodiments, the gateway may itself be a speed transmitter, a device that relays speed from some other source to the sensor(s), or simply a data sending device. The radio transceiver may include a processor, memory, and/or communication circuitry capable of broadcasting speed or other parameters to various sensors on the network or to the configuration and analysis server.

In some embodiments, the radio transceiver may also comprise a gateway or access point compatible with communication technologies such as LoRaWAN, cellular networks, Wi-Fi infrastructure, Bluetooth infrastructure, or other wireless communication systems. It may also contain appropriate interpretation software/firmware to work with standard machine protocols such as Modbus or MQTT See FIG. 2. In some embodiments it may also contain circuitry to change a 4-20 Ma or 0-10V analog signal into a digital signal. See FIG. 3.

The radio transceiver may function as a gateway, base station, access point, relay node, or other infrastructure component that provides connectivity between the sensor and a wider communication network. In some embodiments, the radio transceiver may also relay configuration data between a remote server and the sensor. See FIG. 4. The gateway in this case can be a stand-alone device or a node to transmit data to other sensors, nodes, or to the Analysis and Configuration Server (described below).

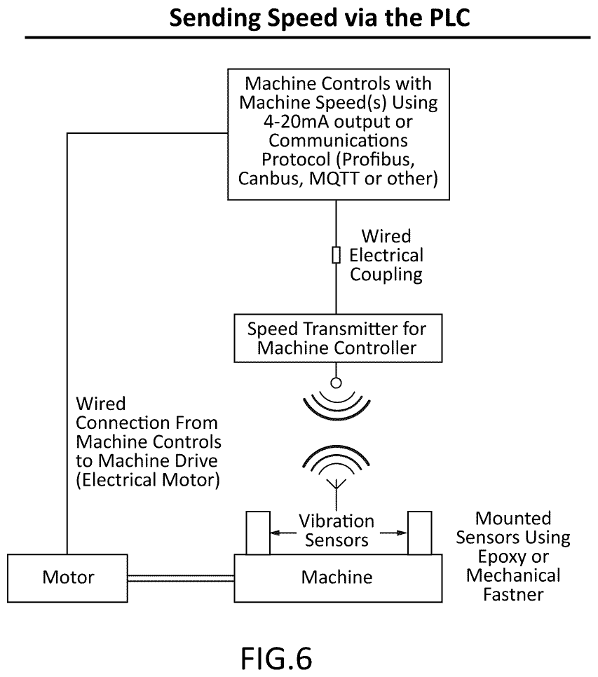

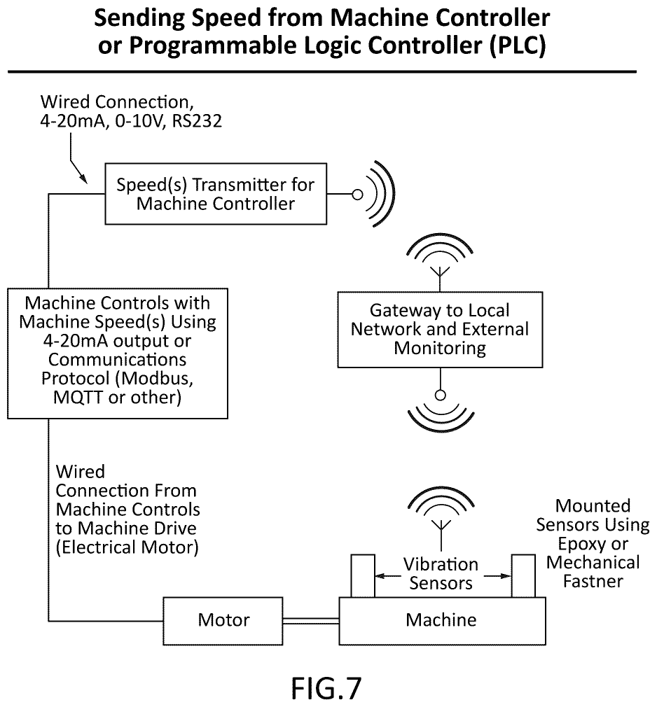

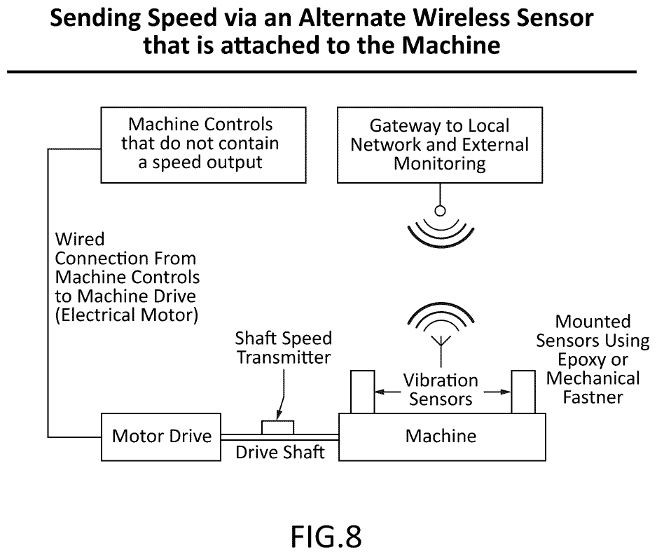

The sensor is shown in the mounted state in FIGS. 6, 7, and 8.

(4) Configuration and/or Analysis Server

This component may be implemented locally and/or as a remote device, the configuration server may comprise one or more computing devices including processors, memory, network interfaces, and storage systems configured to maintain mappings between radio transceiver identifiers, sensor types, and operational modes.

The configuration server may communicate with radio transceivers and sensors via wired or wireless communication networks. The configuration server may be implemented using conventional computing infrastructure such as cloud computing platforms, edge servers, or industrial control systems. The configuration server may generate configuration commands, transmit configuration data, log operational transitions, and update mapping tables based on system policies or external inputs.

The server may also be used as the analysis component for trending, diagnostic analysis or other services and host software for this purpose as needed. See FIG. 5.

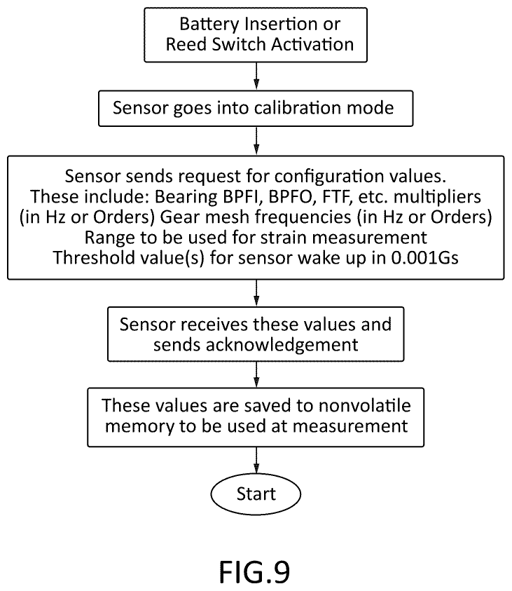

FIG. 9 is a flow chart describing how configuration data is sent and stored on the sensor, in accordance with an exemplary embodiment of the invention. Exemplary action steps in the “Sending Speed to a Wireless Sensor” process are described below.

Configuration—The sensor, upon first battery installation or a reed switch activation, causes the sensor to go into configuration mode. The sensor then sends a request over the communications link for the configuration parameters. These include but are not limited to bearing details (ball pass inner ring, ball pass outer ring, ball spin frequency, and fundamental train frequency), gear details (gear mesh frequencies, gear mesh frequency harmonics, sidebands, and hunting tooth frequency), accelerometer measurement lower and or upper threshold for activation. These values are then saved to nonvolatile memory. Once complete the sensor goes to normal measurement mode.

Initiation and Triggering—The process begins with a measurement trigger, which may be scheduled (e.g., every 15 minutes), event-based (e.g., vibration exceeding a threshold), or cross-triggered (strain changes prompting vibration capture, or vice versa). For enablement, the microprocessor runs firmware (e.g., in C language) with interrupts for ADC sampling. These instructions are monitored and executed by the microprocessor from configuration data saved in non-volatile memory.

Parameter Reception—At measurement time, the sensor requests speed from the network and or wireless speed transmitter. The sensor receives this packet (e.g., a few bytes via BLE advertising or other wireless means), and the MCU parses it using standard libraries like FreeRTOS for task management.

Data Capture—The accelerometer captures raw vibration data (e.g., acceleration in g units over 1024 to 4096 samples).

### On-Sensor Processing/Measurement

Feature Calculation—Using the received speed, the MCU computes speed-dependent features from vibration data. For example: Perform FFT function (using CMSIS-DSP library) to transform time-domain data to frequency domain. This sample will be configurable for a short time period (e.g. 200 milliseconds to 20 seconds). Once complete the microprocessor uses a Hann Window function to reduce spectral bleed and then computes the FFT. Extract orders (e.g., 1×, 2× speed harmonics) by scaling frequencies to RPM multiples: feature value=amplitude at (order*speed/60) Hz. Extract bearing defect feature amplitudes, gear defect features amplitudes by using the saved multipliers for each defect feature. feature value=amplitude at (multiplier*speed/60) Hz. Calculate Other features: RMS velocity, peak-to-peak, kurtosis, etc.

Transmission and Analysis—The sensor wirelessly transmits the calculated features and correlations (e.g., via data packets) to the configuration and analysis server in FIG. 3. There, software trends data, adjusts alarms (e.g., if correlated severity>threshold, alert), and characterizes faults.

These steps reduce data from Kilobytes to bytes thereby reducing transmission time for the sensor, reducing battery requirements and extending life of the system. This also reduces ISM band traffic and potential collisions.

### Strain Measurement and Vibration

FIG. 1 includes an optional strain sensor with capability to receive and incorporate speed data into the computations, in accordance with an exemplary embodiment of the invention.

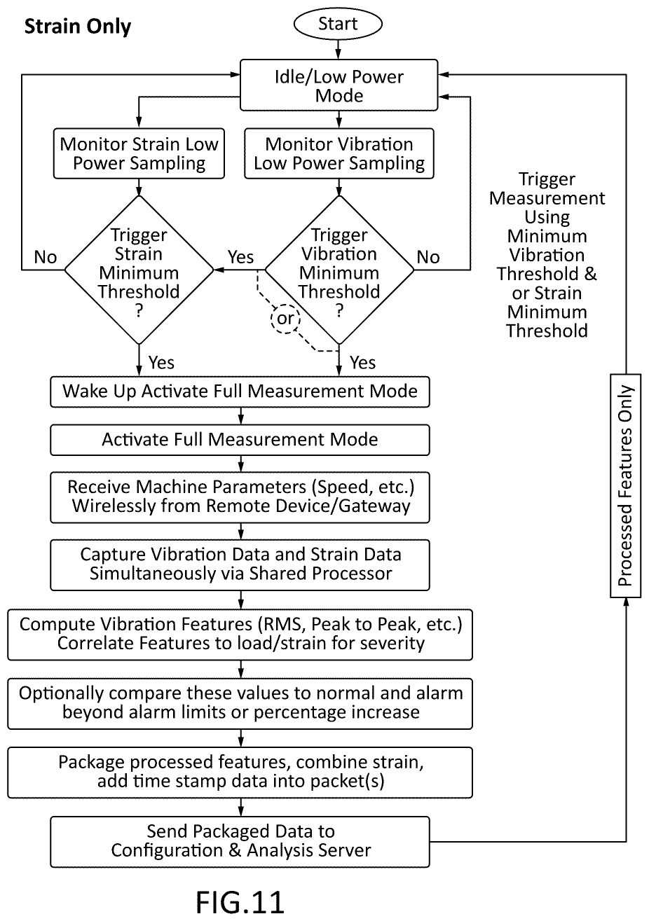

In an embodiment of the invention, the system for carrying out the method shown in FIG. 11 comprises three primary elements: (1) at least a strain measurement sensor; (2) a gateway device; and, (3) a configuration and/or analysis server.

### (1) Strain Sensor

The sensor for combining strain with vibration features uses the same components as detailed in the speed section and adds a strain measurement component, such as a grid type, rosette type, foil strain gauge, or piezoresistive sensor, calibrated to detect load/force changes from at least 1 to 2,000 μstrain. This component is bonded directly to the sensor housing and in such a way to allow for maximum transmission of the machine surface strain. It also incorporates the necessary circuitry to amplify and/or normalize the signal (e.g. Wheatstone bridge, quarter, half, or full depending on application requirements). The strain gauge is integrated into the same housing as the accelerometer for simultaneous measurement, ensuring temporal alignment.

In some embodiments, the strain component is mounted internally to the sensor housing and in some to the outside of the housing. This depends on the machine being monitored and transmissibility of strain in the mounted region or environmental factors.

In some embodiments, the sensor is bonded or affixed to the surface of the machine to provide the maximum strain sensitivity.

### (2) Gateway Device

Each radio transceiver may comprise a wireless communication interface to communicate with one or more sensors. The radio transceiver may include a processor, memory, and communication circuitry capable of broadcasting speed or other parameters to various sensors on the network or to the configuration and analysis server.

In some embodiments, the radio transceiver may also comprise a gateway or access point compatible with communication technologies such as LoRaWAN, cellular networks, Wi-Fi infrastructure, Bluetooth infrastructure, or other wireless communication systems. It may also contain appropriate interpretation software/firmware to work with standard machine protocols such as Modbus or MQTT. See FIG. 2.

The radio transceiver may function as a gateway, base station, access point, relay node, or other infrastructure component that provides connectivity between the sensor and a wider communication network. In some embodiments, the radio transceiver may also relay configuration data between a remote server and the sensor. See FIG. 4.

(3) Configuration and/or Analysis Server

This component may be implemented locally and/or as a remote device. The configuration server may comprise one or more computing devices including processors, memory, network interfaces, and storage systems configured to maintain mappings between radio transceiver identifiers, sensor types, and operational modes. The configuration server may communicate with radio transceivers and sensors via wired or wireless communication networks.

The configuration server may be implemented using conventional computing infrastructure such as cloud computing platforms, edge servers, or industrial control systems.

The configuration server may generate configuration commands, transmit configuration data, log operational transitions, and update mapping tables based on system policies or external inputs.

The server may also be used as the analysis component for trending, diagnostic analysis or other services and host software for this purpose as needed. See FIG. 5.

In an embodiment of the invention, the system operates through a sequence of action steps that optimize wireless data handling and enhance diagnostics, as outlined in the flowcharts of FIGS. 9 and 11. Exemplary action steps in the “Strain Measurement” process are described below.

Configuration—The sensor, upon first battery installation or a reed switch activation, causes the sensor to go into configuration mode. The sensor then sends a request over the communications link for the configuration parameters. These may or may not include and are not limited to bearing details (ball pass inner ring, ball pass outer ring, ball spin frequency, and fundamental train frequency), gear details (gear mesh frequencies, gear mesh frequency harmonics, sidebands, and hunting tooth frequency), accelerometer measurement lower and or upper threshold for activation. These fault frequencies may be ranges or specific frequencies depending on the known speed variability of the machine. These values are then saved to nonvolatile memory for use at the time of measurement. Once complete, the sensor goes to normal measurement mode.

Initiation and Triggering—The process begins with a measurement trigger, which may be scheduled (e.g., every 15 minutes), event-based (e.g., vibration exceeding a threshold), or cross-triggered (strain changes prompting vibration capture, or vice versa). For enablement, the microprocessor runs firmware (e.g., in C language) with interrupts for ADC sampling. These instructions are monitored and executed by the microprocessor from configuration data saved in non-volatile memory. These instructions are monitored and executed by the microprocessor from configuration data saved in non-volatile memory.

Data Capture—The accelerometer captures raw vibration data (e.g., acceleration in g units over 1024 to 4096 samples). Simultaneously, the strain gauge measures deformation (converted to voltage via Wheatstone bridge, amplified, and digitized), providing load context (e.g., torque or stress in Nm or psi).

### On-Sensor Processing/Measurement

Perform FFT function (using CMSIS-DSP library) to transform time-domain data to frequency domain. This sample will be configurable for a short time period (e.g. 200 milliseconds to 1.5 seconds). Once complete the microprocessor uses a Hann Window function or similar to reduce spectral bleed and then computes the FFT. Extract highest peaks amplitudes and frequencies (configurable from one feature per range to many) within the frequency ranges received from the configuration or use specific defect features for bearings and gears by using the saved multipliers for each defect feature from the saved configuration features. feature value=amplitude at (multiplier* shaft speed/60) Hz. Calculate Other features: RMS velocity, peak-to-peak, kurtosis, etc.

Optional Correlation with Strain on sensor—The microprocessor correlates features with strain (e.g., fault severity=vibration amplitude*load factor, where load factor=normalized strain). These values can be compared to previously collected features and alarmed directly or against baseline values. Simple operations like linear scaling or thresholds can be implemented; embedded Machine Learning may also be used (e.g., TensorFlow Lite Micro).

Transmission and Analysis—The sensor wirelessly transmits the calculated features and load (e.g., via data packets) to the configuration and/or analysis server, such as shown in FIG. 5. There, software trends data, adjusts alarms (e.g., if correlated severity>threshold, alert), and characterizes faults (e.g., “bearing wear under high load”).

These steps reduce data from Kilobytes to bytes thereby reducing transmission time for the sensor, reducing battery requirements and extending life of the system. It also reduces congestion on the ISM bands and potential for collisions.

### Strain and Speed Combined

In the interests of brevity, this section relies on the forgoing specific descriptions for sending speed and combining strain with vibration. In an embodiment of the invention, the present methodology combining strain and speed uses the same components, sensor, speed transmitter, gateway, and or nodes.

In this embodiment all components described previously are used in appropriate combination to receive speed at the sensor at the time of measurement. The sensor combines speed to increase accuracy of the frequency selection and strain to better understand amplitudes by combining these machine contexts together at the time of measurement. This reduces false negative, false positives, and greatly streamlines data throughput and reliability of both human analysis as well as machine learning algorithms.

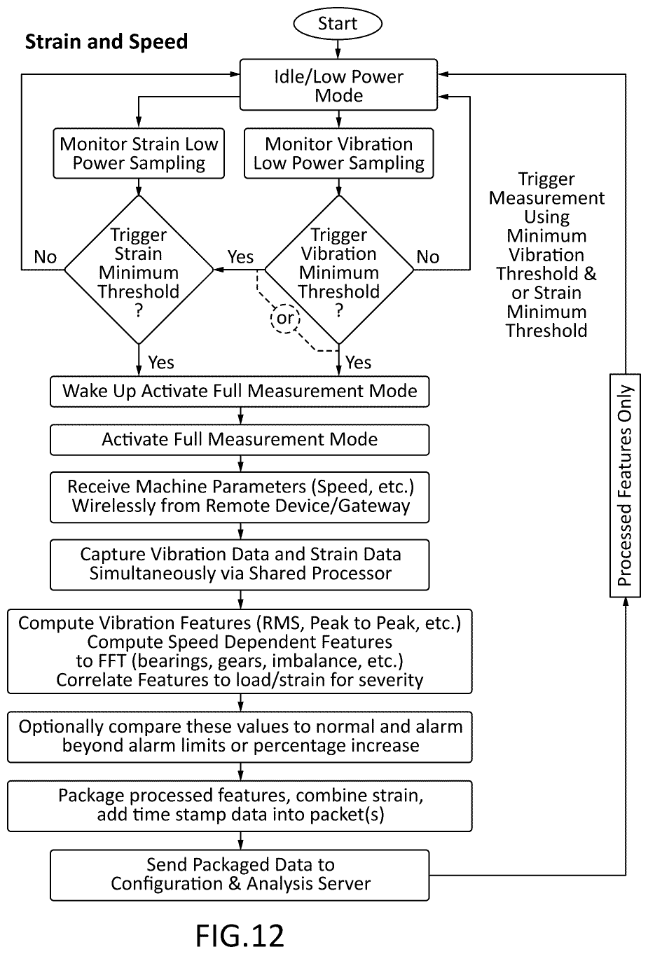

In this embodiment the sensor uses the same process steps as before with the following modifications and described in FIG. 12 and described below. Using the received speed, the MCU computes speed-dependent features from vibration data. For example:

Perform FFT function (using CMSIS-DSP library) to transform time-domain data to frequency domain. This sample will be configurable for a short time period (e.g. 200 milliseconds to 20 seconds). Once complete the microprocessor uses a Hanning Window function to reduce spectral bleed and then computes the FFT.

Extract orders (e.g., 1×, 2× speed harmonics) by scaling frequencies to RPM multiples: feature value=amplitude at (order*speed/60) Hz.

Extract bearing defect frequency feature amplitudes and gear defect frequency features amplitudes by using the saved multipliers for each defect feature. feature value=amplitude at (multiplier*speed/60) Hz

Calculate Other features: RMS velocity, peak-to-peak, kurtosis, etc.

Optional Correlation with Strain on sensor: The microprocessor correlates features with strain (e.g., fault severity=vibration amplitude*load factor, where load factor=normalized strain). These values can be compared to previously collected features and alarmed directly or against baseline values. Simple algorithms like linear scaling or thresholds can be implemented; embedded Machine Learning may also be used (e.g., TensorFlow Lite Micro).

Transmission and Analysis: The sensor wirelessly transmits the calculated features and load (e.g., via data packets) to the configuration and/or analysis server, and example of which is shown in FIG. 5. There, software trends data, adjusts alarms (e.g., if correlated severity>threshold, alert), and characterizes faults (e.g., “bearing wear under high load”).

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3 , 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

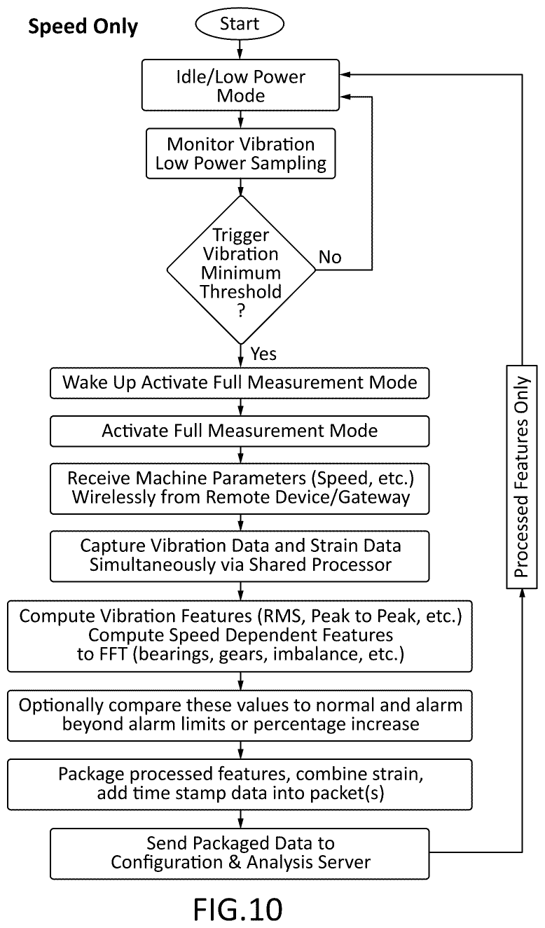

The following example scenarios illustrate representative implementations of the systems and methods described herein and are consistent with the architectures and processes shown in FIGS. 1-12, where FIGS. 6, 7 and 8 could be a pump, fan, gearbox, or other rotating piece of equipment. These examples are provided solely to demonstrate practical application of the disclosed concepts and are not intended to limit the scope of the invention. These examples are illustrative and not limiting; variations may combine elements from different examples or adapt to other sectors like automotive manufacturing or aerospace testing, where the invention's wireless intelligence provides scalable, efficient predictive maintenance.

### Example 1: Paper Mill Gearbox Monitoring

In one embodiment, the system is deployed in a paper mill where wireless vibration sensors are mounted on gearboxes driving rollers and pulpers. Paper mill gearboxes often exhibit multiple gear mesh frequencies (GMFs) due to multi-stage gearing, which can vary with operational speeds and lead to faults like tooth wear or misalignment if not properly contextualized. The remote device (e.g., a mill control PLC integrated with a wireless gateway) transmits real-time rotational speed data (e.g., 500 -1500 RPM) to the sensor during measurement cycles. The sensor's microprocessor uses this speed to calculate GMF-related features, such as harmonics at 1×, 2×, and sidebands (e.g., feature frequency=gear teeth count*speed/60 Hz), via onboard FFT processing. Processed features (e.g., normalized GMF peaks) are wirelessly transmitted to a central analysis device, reducing data volume from raw waveforms (~2 KB) to compact packets (<300 bytes), enabling battery life extension to years from months in a high-humidity environment. This embodiment enhances fault detection reliability, preventing downtime that could cost $10,000+ per hour in production losses.

### Example 2: Oil and Gas Pump Diagnostics

In this embodiment, the invention targets reciprocating pumps in oil and gas extraction, where fluid viscosities and pressures lead to variable speeds (e.g., 200-600 strokes/min) and loads (e.g., from light crude to heavy slurries). Sensors are placed on the pump impeller housing and bearing housing. Setup mode auto-derives amplitudes of fault frequencies of bearings and impeller blades (e.g., 2× for valve chatter) via a sweep of speeds test pumping at baseline rates. The speed transmitter unit sends speed from a control unit, facilitating feature calculation like peak acceleration. Data packets are transmitted via LoRa to a local gateway, reducing bandwidth for hazardous ATEX-certified zones and enabling proactive maintenance to avoid spills or explosions.

### Example 3: Mining Conveyor Belt Systems

In a mining application embodiment, sensors monitor conveyor drives and idlers in underground or open-pit operations with varying speeds (e.g., 1-5 m/s). Calibration sets multipliers for belt frequencies (e.g., 1× roll, 0.5× splice). The gateway provides speed from encoders, with on-sensor processing for misalignment features. Wireless mesh over 802.15.4 supports deep-mine distances, with minimal data transmission aiding in dust-heavy, signal-challenged environments.

### Example 4: Constant-speed Machines in Oil and Gas With Embedded Strain for Load Monitoring

In this embodiment, the wireless vibration sensor system is applied to constant-speed rotating equipment in the oil and gas industry, such as centrifugal pumps, fin-fan coolers (air-cooled heat exchangers), and blowers/compressors in upstream production facilities, refineries, or offshore platforms. These machines typically operate at fixed speeds (e.g., 1,800 RPM or 3,600 RPM synchronized to 60 Hz electrical supply) driven by induction motors, where direct speed measurement is often impractical due to hazardous (ATEX/IECEx-rated) zones, enclosed or inaccessible shafts, or the absence of tachometer provisions. The integrated embedded strain component (e.g., a foil or piezoresistive strain gauge embedded in the sensor's mounting base or directly coupled to the machine housing) provides real-time load readings by detecting deformation, torque, or thrust variations caused by changes in process conditions like fluid density, discharge pressure, or flow rate.

For example, in an offshore platform's seawater lift pump or produced water injection pump, the sensor captures basic vibration features (e.g., RMS acceleration, peak velocity, or kurtosis for cavitation/impeller issues) without speed-dependent processing. The embedded strain measures load fluctuations (e.g., from high-viscosity crude or pressure surges), correlating them to scale vibration severity—for instance, moderate cavitation-induced vibration is classified as low-severity under low strain (normal flow) but high-severity under elevated strain (overloaded or restricted flow), indicating accelerated wear on bearings or seals. Similarly, for fin-fan coolers in a refinery, strain detects fan blade loading from airflow restrictions or ambient temperature changes, normalizing vibration amplitude to flag imbalance or bearing faults only when load confirms operational stress. In gas compressor auxiliaries (e.g., lube oil pumps), strain correlates with vibration to assess severity under varying system pressures.

The setup mode establishes baseline strain thresholds using controlled no-load vs. full-load tests, storing normalization factors in the sensor's non-volatile memory. Processed load-correlated severity metrics (e.g., normalized RMS values) are wirelessly transmitted (e.g., via intrinsically safe Bluetooth Low Energy or LoRa in hazardous areas) to a central analysis device, minimizing data volume for efficient battery life in remote or explosion-proof environments. This load-focused approach enhances predictive maintenance reliability for constant-speed assets, reducing unplanned downtime and safety risks in high-stakes oil and gas operations.

### Example 5: Constant-speed Pumps in Water Treatment Facilities With Embedded Strain for Load Monitoring

In this embodiment, the system targets constant-speed centrifugal pumps in municipal or industrial water and wastewater treatment plants, such as influent lift stations, effluent transfer pumps, or recirculation pumps in aeration basins. These pumps run at fixed speeds (e.g., 1,200-3,600 RPM) via line-powered motors, where speed ascertainment is difficult due to submerged installations, wet-well enclosures, or the lack of integrated tachometers in legacy equipment. The wireless sensor's embedded strain component (e.g., integrated into the mounting flange or casing interface) captures load variations from fluctuating inflows, head pressures, sludge viscosity, or valve throttling, providing essential context for vibration-based diagnostics.

For instance, in a wastewater treatment plant's primary influent pumps, the sensor measures generic vibration features (e.g., RMS velocity for bearing wear or broadband energy for cavitation) on-sensor. The embedded strain detects dynamic loads (e.g., thrust or torque changes from high inflow during storms or low flow at night), correlating them to adjust fault magnitude—similar vibration levels might indicate minor issues under low strain (normal diurnal flow) but severe cavitation or impeller damage under high strain (surge events or blockages). In potable water treatment booster pumps, strain monitors pressure-related loading, scaling vibration severity to differentiate normal operation from progressive faults like misalignment amplified by head variations. For submersible pumps in remote lift stations, this enables accurate severity assessment without external speed data.

Setup mode calibrates strain baselines through operational tests (e.g., dry-run vs. full-flow conditions), storing scaling parameters for ongoing use. Load-normalized severity data is transmitted wirelessly (e.g., over Wi-Fi or cellular for plant-wide coverage) with reduced payload, supporting long battery life or energy-harvesting in wet, corrosive environments. This embodiment improves predictive maintenance for constant-speed pumps in water treatment, preventing overflows, energy waste, and regulatory violations by focusing on load-aware fault magnitude in variable-flow applications.

### Example 6: Wind Turbine Blade and Gearbox Monitoring

In another embodiment, the system is implemented in wind farms for monitoring turbine blades and nacelle gearboxes, where drivetrains run at near constant speeds. In this case the strain measurement is a good proxy for speed as speed and load have very high correlation to one another. In this case speed is difficult to transmit but adding a strain measurement is easy. At the point of commissioning, the fault frequencies are configured as ranges of frequencies for each bearing and gear mesh. This leverages the flexibility of the system and makes for much simpler installations.

### Example 7: Tow Boat Barge Propulsion Monitoring

In this embodiment, the system is deployed on a tow boat (tugboat) used for pushing barges along inland waterways or coastal routes, such as in river freight transport for commodities like coal, grain, or petroleum. The tow boat features two separate drive trains, each with its own engine, propeller shaft, and gearbox, allowing for independent operation to enhance maneuverability and redundancy. Operational loads vary dramatically depending on the barge configuration—pushing an empty barge imposes minimal resistance (e.g., low torque and vibration), while a fully loaded barge (e.g., 1,500-3,000 tons) significantly increases drag, stress on gearboxes, and potential for faults like shaft misalignment or bearing overload. Wireless vibration sensors with integrated strain components are mounted on each gearbox and shaft coupling, capturing these differences in real-time.

### Example 8: Wastewater Treatment Plant Pump System

In this embodiment, the system is applied to a municipal wastewater treatment plant, where a network of centrifugal and submersible pumps manages high-volume water flow through various treatment stages, such as influent pumping, aeration, and effluent discharge. Wastewater treatment facilities often handle fluctuating inflows (e.g., 1-50 million gallons per day) due to diurnal patterns, storm events, or population demands, resulting in variable head pressures (e.g., 20-100 feet) influenced by tank levels, sludge density, and downstream resistance. A real-world example includes systems like those in large urban plants (e.g., the Stickney Water Reclamation Plant in Chicago or similar facilities), where variable frequency drives (VFDs) and multiple pumps are used to adapt to these changes, as seen in applications for variable flow and head pumping in water systems. Here, wireless vibration sensors with integrated strain components are mounted on each pump's casing, impeller shaft, or discharge bearing housing in a multi-pump setup (e.g., parallel primary and backup pumps for redundancy).

During the setup mode, multipliers for speed orders (e.g., 1× for impeller rotation, 2× for cavitation harmonics) are calibrated using controlled flow tests at baseline pressures (e.g., simulating low vs. high inflow). In operation, the remote speed transmitter is combined with the pumps controllers and wirelessly transmits rotational speeds from VFD controllers or flow meters, enabling on-sensor computation of features such as RMS velocity or spectrum analysis for clogging detection.

The strain gauges capture dynamic head pressures and load variations (e.g., from viscous sludge or surge events), correlating them with vibration data to assess fault severity—for instance, a vibration amplitude increase at 1.5× speed might signal impeller wear only under high-head conditions (>50 feet), preventing over-alerting during low-flow periods.

This approach differentiates normal operational variability from emerging issues like bearing fatigue. Processed features and correlations are transmitted over a robust wireless protocol (e.g., Wi-Fi or cellular for plant-wide coverage), minimizing data volume to support energy-efficient monitoring of 20+ pumps, ultimately reducing downtime and maintenance costs in an environment where interruptions can lead to environmental overflows or regulatory fines.

### Example 9: Railway Locomotive and Rail Car Monitoring

In this embodiment, the system is implemented on a freight or passenger train, where wireless vibration sensors are mounted on critical components such as locomotive axles, wheel bearings, gear mesh, or rail car bogies to monitor for faults like wheel flats, bearing defects, or track-induced vibrations. Train operations involve highly variable speeds (e.g., 0 -200 mph) influenced by terrain, signaling, and load, making real-time speed context essential for accurate fault frequency analysis. Speed is calculated from a GPS unit resident on the locomotive (e.g., integrated with onboard telematics systems like those from Wabtec), providing precise velocity data without relying on wheel-mounted tachometers that can fail in slippery conditions.

In operation, the GPS-derived speed is transmitted from the locomotive to a remote analysis/configuration server (e.g., a cloud-based platform via satellite or cellular uplink), which processes and automatically forwards the speed signal wirelessly to the distributed sensors across the train consist. The sensors' microprocessors use this received speed to compute fault frequencies, such as wheel rotation orders (e.g., 1× for fundamental, 2× for out-of-roundness) via FFT, scaling them dynamically (e.g., fault frequency=order*speed*wheel circumference conversion).

Simultaneously, integrated strain gauges measure load variations (e.g., from cargo weight or dynamic forces during acceleration/deceleration), correlating them with vibration features to assess severity—for instance, a harmonic peak might indicate a minor track irregularity at low speed but a critical bearing issue under high-speed, heavy-load conditions.

During setup mode, multipliers for rail-specific harmonics (e.g., accounting for rail joint spacing) are calibrated using initial test runs at controlled speeds. Processed features and correlations are transmitted back to the remote server over a train-wide wireless network (e.g., Wi-Fi mesh or LTE), minimizing data volume for efficient bandwidth use in remote or tunnel-prone routes, enabling predictive maintenance to prevent derailments and reduce downtime in an industry where delays can cascade across networks.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for predictive maintenance of machinery, comprising:
a vibration sensor configured to measure vibration data of a machine;
a strain measurement component integrated within the vibration sensor, configured to measure strain data indicative of load or force on the machine simultaneously with the vibration data;
a remote device communicatively coupled to the vibration sensor over a network, configured to wirelessly transmit at least one machine parameter, including rotational speed, to the vibration sensor at the time of vibration measurement;
a microprocessor in the vibration sensor configured to wirelessly receive the at least one machine parameter from the remote device, calculate at least one vibration feature from the vibration data based on the at least one machine parameter, and correlate the at least one vibration feature with the strain data to diagnose a state of the machine, including fault severity under the measured load; and,
wherein the vibration sensor is further configured to wirelessly transmit the at least one calculated vibration feature and the correlated strain data over the network to a data collection and analysis device for further processing, analysis, or trending, thereby reducing data transmission volume, transmission time, and power consumption by avoiding transmission of raw vibration data.

2. The system of claim 1, wherein at least one of the vibration sensor and the network is wireless.

3. The system of claim 1, wherein the strain measurement component is configured to trigger the vibration measurement based on detected strain changes, or the vibration sensor is configured to trigger the strain measurement based on vibration events.

4. The system of claim 1, wherein the vibration sensor is configured to report the calculated vibration feature and correlated strain data over a radio network for deployment across a plurality of machines in an industrial environment.

5. The system of claim 1, wherein the data collection and analysis device is configured to automatically adjust alarm limits or characterize fault severity in real time using received correlated vibration feature and strain data.

6. The system of claim 1, wherein the at least one machine parameter transmitted to the sensor further includes one or more of temperature, pressure, or operational status.

6. The system of claim 1, wherein the vibration sensor is mounted on a gearbox, pump, fan, axle, wheel bearing, drivetrain, or rotating machinery.

7. A method for predictive maintenance of machinery using a vibration sensor, comprising:
measuring vibration data of a machine with the vibration sensor;
measuring strain data indicative of load or force on the machine simultaneously with the vibration data using a strain measurement component integrated within the vibration sensor;
receiving, at the vibration sensor, at least one machine parameter, including rotational speed, transmitted from a remote device over a wireless network at the time of vibration measurement;
calculating, via a microprocessor in the vibration sensor, at least one vibration feature from the vibration data based on the at least one machine parameter;
correlating the at least one vibration feature with the strain data to diagnose a state of the machine, including fault severity under the measured load; and,
transmitting the at least one calculated vibration feature and the correlated strain data over the network to a data collection and analysis device for further processing, analysis, or trending,
wherein the method reduces data transmission volume, transmission time, and power consumption by transmitting the at least one calculated vibration feature instead of raw vibration data.

8. The method according to claim 7, wherein at least one of the vibration sensor, network, receiving and transmitting are wireless.

9. The method of claim 7, further comprising triggering the vibration measurement based on the strain data, or triggering the strain measurement based on the vibration data.

10. The method of claim 7, wherein wirelessly transmitting occurs over a radio network for deployment across a plurality of machines.

11. The method of claim 7, further comprising automatically adjusting alarm limits or characterizing fault severity using the correlated vibration feature and strain data at the data collection and analysis device.

12. The method of claim 7, wherein the at least one machine parameter wirelessly received further includes one or more of temperature, pressure, or operational status.

13. The method of claim 7, wherein the vibration sensor is mounted on a gearbox, pump, fan, axle, wheel bearing, drivetrain, or rotating machinery.
